(19) United States
(12) Patent Application Publication
(10) Pub. No.: US 2026/0346879 A1
(43) Pub. Date: Nov. 5, 2026

(54) DRONE DRIVING SYSTEMS AND METHODS

(71) Applicant: B. G. NEGEV TECHNOLOGIES AND APPLICATIONS LTD., AT BEN-GURION UNIVERSITY, Beer Sheva (IL)

(72) Inventor: David ZARROUK, Beer Sheva (IL)

(73) Assignee: B. G. NEGEV TECHNOLOGIES AND APPLICATIONS LTD., AT BEN-GURION UNIVERSITY, Beer Sheva (IL)

(21) Appl. No.: 19/488,467

(22) PCT Filed: May 30, 2024
(86) PCT No.: PCT/IB2024/055271

§ 371 Date: Nov. 26, 2025

Related U.S. Application Data
(60) Provisional application No. 63/470,194, filed on Jun. 1, 2023.

(51) Int. Cl. B61B 7/06; B64F 3/00; B64U 10/14; B64U 101/64

(52) U.S. Cl. CPC B61B 7/06; B64F 3/00; B64U 10/14; B64U 2101/64

(57) ABSTRACT

Embodiments pertain to drone driving system, comprising: a guideway that is elevated above a reference surface and extending along a route; and a coupling hardware, wherein the coupling hardware is configured to operably engage with the guideway for driving a drone that is coupled with the coupling hardware along the guideway. In some examples, when the drone is operably engaged with the guideway, no gravitational force, less than 50%, 50%, more than 50%, or all of the gravitational force acting onto the drone is borne by the guideway. In some examples, the coupling hardware and guideway are configured such that an airborne drone can operably engage with the guideway.

### CROSS-REFERENCE TO RELATED APPLICATIONS

This patent application claims priority and/or benefit from U.S. provisional patent application 63/470,194, filed Jun. 1, 2023, titled “Flying And Wire Driving Drone”, and which is incorporated herein by reference in its entirety.

### BACKGROUND

Drones have been widely used for different applications such as filming, monitoring, and surveillance. In the last decade, there have been significant improvements in increasing their reliability, flight range, and flight control. Modern drones have a higher positional accuracy enabling them to travel relatively accurately within a planned trajectory. Drones have also been fitted with taking off, flying, and landing autonomous controllers.

In recent years, there have been continuous attempts to use drones to deliver packages (goods, medicine, and parts) and replace the standard delivery vehicles for the last mile, one of the journey's most expensive and challenging parts. Since multiple packages can reach a destination neighborhood, each package must be delivered independently. Using drones can substantially decrease the time and cost of the deliveries and, as a result, cut the total cost of goods and reduce street traffic. Drones can improve logistic efficiency and potentially be used for delivery of foods, medication, security, leisure activities, and/or the like.

The description above is presented as a general overview of related art in this field and should not be construed as an admission that any of the information it contains constitutes prior art against the present patent application.

### BRIEF DESCRIPTION OF THE DRAWINGS

Non-limiting examples of embodiments disclosed herein are described below with reference to figures attached hereto that are listed following this paragraph. The drawings and descriptions are meant to illuminate and clarify embodiments disclosed herein and should not be considered limiting in any way. Like elements in different drawings may be indicated by like numerals. Elements in the drawings are not necessarily drawn to scale.

FIG. 1 is a schematic illustration of a drone driving system, according to some embodiments.

FIGS. 2A and 2B are schematic illustrations of a drone operably coupled with a guideway of a drone driving system, according to some embodiments.

FIG. 3A is a schematic illustration of a drone operably coupled with a guideway of a drone driving system, according to some other embodiments.

FIG. 3B is a schematic illustration of coupling hardware of a drone, according to some embodiments.

FIG. 4 is a schematic illustration of different drone roll orientations relative to a guideway, according to some embodiments.

FIG. 5A is a schematic illustration of a drone that has a non-angled orientation relative to a coupling hardware, according to some embodiments.

FIG. 5B is a schematic illustration of a drone that has an angled orientation relative to a coupling hardware, according to some embodiments.

FIGS. 6A to 6C are schematic illustrations of docking a drone onto a guideway's docking station, according to some embodiments.

FIG. 7 is a flowchart of a drone driving method, according to some embodiments.

### DETAILED DESCRIPTION

Usage of drone-based deliveries may be limited due to their inability to safely reach the end customer, for a variety of reasons. For example, drones may require a landing zone meeting minimum landing area requirements. Since landing location may not be accurate, package placement radius may be comparatively extended with respect to densely populated and range, for example, from at least 0.5 meters to at least 1 meter. Ensuring a minimum landing zone radius may not always be available and is often impractical. For instance, in densely populated residential and commercial zones, a landing area meeting minimum landing area requirements for allowing a drone to land may not be available.

On the other hand, dropping packages from flying drones, instead of landing the drone for delivering the package, may also not be feasible as dropping the package may damage its contents and present danger to persons located in the vicinity of a drop-off area.

In addition, many countries, jurisdictions, and/or authorities, impose flight regulation limitations on drones traveling over and near populated zones and neighborhoods.

Furthermore, considering that drones take off and land vertically, packages are normally deployed in unsheltered locations. Sheltering a drone before vertical take and after having landed vertically requires specialized equipment. Accordingly, absent such specialized equipment, drones are subjected to adverse weather conditions (e.g., sun, rain, snow), potentially endangering the drone and the goods carried by the drones.

In addition, drones are relatively noisy, potentially causing nuisance to residents and workers, which can be particularly problematic at night, weekends, and during holidays. While airborne, drones may also present a danger to traffic participants such as, for example, pedestrians, vehicles, bikers, and/or the like; and may also potentially collide along their flight with objects in the scene such as, for example, tree branches, power transmission lines, buildings, glass facades, and/or the like.

Drones also have a limited energy capacity, limiting their traveling distances and payloads, adverse environmental conditions such as, for example, rain, fog, heat, cold temperatures, dust, sand, winds, snow, and/or hail, can affect the flying drone's positional accuracy and energy requirement.

Embodiments of the systems, devices and methods discussed herein may overcome some of the aforementioned issues by providing a drone with a coupling hardware and further by providing a guideway that extends along a (e.g., predetermined) route along a longitudinal axis Zg between two endpoints, which may or may not have a same height above ground. In some examples, a portion of the guideway may extend horizontally above a reference surface, and another portion of the guideway, which may interface with the first portion, may extend vertically towards the ground. In some examples, guideway may travers along a curved path, extending vertically and/or horizontally relative to a reference plane such as the Earth surface. In some examples, the guideway may be sloped relative to a reference plane. In some examples, a guideway may be considered to be a suspension track and/or guide track.

The coupling hardware may herein also be referred to as grasping mechanism. The drone may attach with the guideway at an interface location to facilitate travel of the drone from the interface location to a target location, e.g., while the drone is suspended from the guideway. The coupling hardware and guideway are configured to allow securely coupling a flying drone with the guideway at an interfacing location, and unsecuring and decoupling the drone from the guideway, as necessary, so that the drone can again become airborne. The guideway may thus constitute a drone landing and launching platform.

The coupling hardware may include a lock mechanism for selectively securing and unsecuring the coupling hardware with the guideway. A process of securing the coupling hardware with the guideway so that the drone can travel along the longitudinal axis Zg may herein also be referred to as “operably engaging” the coupling hardware, and therefore, the drone, from the guideway. Once and while the drone is operably engaged with the guideway, the drone's travel direction is confined by the guideway's route. The longitudinal axis Zg may traverse in any direction above ground, underground (e.g., in a tunnel) and/or relative to a reference plane, e.g., parallel straight above ground, curved, above ground; in any vertical direction above ground (e.g., traversing a curved or straight path), and/or the like. The guideway may be configured so that a plurality of drones can concurrently drive along the guideway.

In some examples, the drone may travel along a guideway that is located in a no-fly zone. With the employment of one or more guideways, a drone can be used for the delivery of goods with pinpoint accuracy. For example, a drone can fly towards a house, attach itself to a guideway that leads to the house, drive along the guideway to reach its final destination for delivering the goods.

In some examples, guideways may be installed such that a drone, while traveling along the guideways, can be used for the monitoring, inspection and/or maintenance of various installations, equipment, (e.g., functional) facilities, buildings (e.g., building walls and/or skyscraper rooftops), and/or the like. For example, one or more guideways may be installed so that drones comprising sensors can monitor and/or test industrial equipment (e.g., solar panels, power lines, vessels, tanks, ships, aircrafts, hangars, shipyards, pipelines, fluid storage containers, transfer containers for, e.g., oil, gas, water; and/or the like). For instance, the drone driving system may be configured for cleaning, imaging, and/or non-destructive testing of industrial and non-industrial equipment and facilities. Optionally, a drone may be equipped with non-destructive testing sensors, and the guideways may be installed relative to equipment so that a drone traveling along the guideways can non-destructively evaluate and/or monitor the equipment. In some examples, the drone may be equipped with cleaning and/or other apparatuses for the maintenance of equipment. In some examples, guideways may not only be used in unmanned drone applications, but also in manned or staffed applications. For instance, a manned aircraft may comprise coupling hardware for operably engaging the manned aircraft with guideways. A coupling hardware may be configured to operably engage with a

Guideways may also be installed such that a drone can be used in homeland security applications, perimeter surveillance applications, monitoring of functional facilities (e.g., office buildings, hospitals), and/or the like, for the surveillance of borders, residential areas, monitoring of industrial complexes, commercial areas, and/or the like. In some examples, guideways may be installed at different heights relative to each other so that drones can monitor and/or fly between different floor heights of a building.

In some embodiments, guideways may be installed indoors (e.g., in warehouses) for the conveyance of goods between various locations. In some examples, wheels may be coupled with goods for rolling the goods over a supporting surface. A height between a guideway and a corresponding supporting surface may be such that when a drone travels along the guideway, the wheels rotate or roll over the supporting surface. In some examples, a drone may comprise wheels which are configured such that when the drone travels along the guideway, the wheels roll or rotate over a supporting surface located underneath. In some examples, the drone may comprise a wheel mechanism configured so that when the drone travels along the guideway, the wheels are rolling over a supporting surface (e.g., a ground surface). Such wheel mechanism may be selectively extendable and retractable. Instead, or in addition to wheels, slides may be employed configured to slide above the supporting surface.

In some examples, a drone may function as a temporary communication hub, e.g., when operably engaged with a guideway. In some examples, the drone may be equipped with wheels that can roll over the supporting surface.

In some embodiments, at least one of one or more guideways may function as a platform for sequentially launching a plurality of drones. Analogously, at least one of one or more guideways may function as a landing platform sequentially receiving, by the at least one guideway, a plurality of drones. The launching and landing of drones from guideways may occur on a non-stationary (e.g., driving) platform.

At least a portion of the guideway may be deployed at some distance above ground to facilitate coupling an airborne drone thereto. Once the drone is coupled with the guideway, the drone can be guided along the guideway from the drone-guideway interface to the target location. Analogously, the drone can be guided along the guideway from the target location to the drone-guideway interface, where it may become again unguided by the guideway and, therefore, airborne.

Employing guideways may allow guiding a drone to a target in an environment without utilizing a Global Navigation Satellite Systems (GNSS) such as, for example, GPS, GLONASS. The drone driving system may thus facilitate causing a drone to reach a target that is located in a GNSS-free, GNSS-denied or GNSS-challenged environment.

By coupling the drone to the guideway, most or all of the weight to which the drone was subjected to during flight may be borne (also: supported) by the guideway and the energy that is required for the drone to travel between the interface and the target is significantly reduced compared to the energy that would be required if the drone to had fly to and from the target. If the guideway bears at least some gravitational force acting onto the drone, a corresponding remainder amount the energy must now only be used for driving or propelling the drone in a horizontal plane, which spans perpendicular to the Earth's gravitational force, thereby optionally, extending a drone's hardware lifespan and battery life. In some examples, when operably engaged with the guideway, no gravitational force acting onto the drone may be borne by the guideway. In some examples, when operably engaged with the guideway, some gravitational force acting onto the drone may be borne by the guideway. In some examples, when operably engaged with the guideway, less than 50%, 50% or more than 50% of the gravitational force acting onto the drone may be borne by the guideway. In some examples, when operably engaged with the guideway, all gravitational force acting onto the drone may be borne by the guideway.

Once the drone is securely coupled with the guideway via the coupling hardware, the drone's movement may be restricted in any direction which is orthogonal to the guideway's longitudinal Zg axis.

In some embodiments, the guideway may include, for example, a rope, a wire, cable, a conduit, a tube, a pipe, a track, and/or any other equipment allowing to securely couple thereto a drone via the coupling hardware. In some examples, a drone may be retrofitted with coupling hardware. In some other examples, the drone may be configured (e.g., manufactured) to comprise the coupling hardware. In some examples, the coupling hardware may facilitate coupling a drone onto a guideway. In some examples, the guideway may be a tubed guideway, and the drone may be configured to travel within the tubed guideway.

In some embodiments, the coupling hardware and the guideway may herein be collectively referred to as a drone driving system. The drone may or may not be considered part of the system. In some example

By employing a guideway for guiding a drone to and from a target, the drone may for example travel within a restricted flying zone, and/or the impact of adverse environmental conditions may be reduced.

Various embodiments may be employed for causing a drone to traverse a path along the guideway. For example, the drone may be fixedly coupled with the guideway with respect to the guideway's longitudinal extension, such that driving the guideway (e.g., by pulling a cable) causes corresponding displacement of the drone along the path. In another example, the coupling hardware may include a drive (also: motor) configured for driving the drone along the guideway while the guideway remains stationary along the Z-axis with respect to a reference frame. For example, a point or all points of the guideway may remain stationary relative to a reference frame, and the drone docking station may travel along the guideway by moving relative to the same reference frame. For example, a point or all points of the guideway may remain stationary relative to a reference frame, and the coupling hardware with the drone coupled thereto, may travel along the guideway by traveling or moving relative to the same reference frame. The Earth coordinate system may be such a reference frame. The guideway may be stationary relative to the Earth coordinate system. In some examples, a platform comprising a drone driving system may be such a reference frame. The platform may be a stationary or a moving platform relative to the Earth coordinate system. A drone may also undock from a docking station. In some examples, a plurality of drones may dock onto and undock from the same docking station.

It is noted that terms such as “reference frame”, “reference coordinate system”, and/or the like, may herein be used interchangeably.

For instance, the coupling hardware may include a drone drive configured for imparting a driving force onto wheels of the coupling hardware to cause the drone to move along the guideway. In some embodiments, the coupling hardware may be located on the underside of the drone's main body, or at the side of the main body. In some embodiments, the coupling hardware may be located at the same side as the drone's propellers. A drone drive may include a servomotor.

In some embodiments, the drone's propellers may provide thrust for advancing the drone along the guideway. In some examples, the coupling hardware may be configured to allow controlling the one or more orientations of the coupling hardware relative to the drone. This way, the propellers can be used to provide thrust for advancing the drone. For example, a rotational joint may be employed which may allow opening an angle between the coupling hardware and the drone. When the propellers provide thrust, the wheel may not be driven (e.g., passive), or at least one wheel may also be an active wheel for providing additional driving force.

In some examples, the drone can be transported along the guideways Z-direction at multiple meters per second.

The drone driving system may include various sensors including inertial and/or non-inertial sensors configured to provide sensor outputs. Based on sensor outputs, the flight of drone and/or the traveling of the drone along the guideway may be controlled. Sensor outputs may relate, for example, to drone speed, altitude, orientation in space, and/or travel direction while flying and/or when being operably engaged with the guideway. In some examples, drone travel speed on the guideway may be measured using encoders for rotation sensing of wheels operably engaging with the guideway and/or of wheels or pulleys causing guideway (e.g., transport cable) displacement.

Non-inertial sensors may include, for example, one or more barometers, proximity sensors, altimeters, magnetometers, a compass, light sensors (e.g., for measuring the amount of incident sunlight), tactile sensors (e.g., touch screen sensors), microphones, active and/or passive distance measurement sensors, receivers of a space-based satellite navigation system, a camera, and/or a chemical sensor. The drone and/or the guideway may include non-inertial sensors. Inertial sensors may include, for example, a gyroscope and/or an accelerometer. In some embodiments, drone position and orientation may be provided by a receiver of a space-based satellite navigation system (e.g., GPS, GLONASS), by apparatuses for implementing a navigation system that is not based on a satellite system (e.g., SLAM), and/or an inertial sensor.

In some embodiments, the drone driving system may be configured to detect when the drone is operably engaged with the guideway, and when the drone has detached from the guideway. For example, the drone driving system may include one or more force sensors configured to sense when the guideway and/or the coupling hardware is subjected to a coupling force as a result from operable engagement of the coupling hardware with the guideway. Analogously, force sensors may be employed for sensing operable disengagement of the coupling hardware from the guideway. Force sensors may also be employed for sensing additional weight applied onto the guideway, as a result of operable engagement of the coupling hardware with the guideway and, analogously, for sensing a reduction in weight as a result of operable disengagement of the coupling hardware with the guideway.

The coupling hardware and/or the guideway may include force sensors. In some examples, operable engagement and/or disengagement between the coupling hardware and the guideway may be detected by other additional and/or other sensors such as, for example, one or more image sensors, proximity sensors, and/or any other suitable inertial and/or non-inertial sensors. For example, detection of operable engagement and engagement may be image-based.

Once the drone driving system detects operable engagement of the coupling hardware with the guideway, the drone may be driven by or on the guideway to the target. Drone driving speed, acceleration, deceleration, drone orientation, and/or direction of the drone while being operably engaged with the guideway may be image-based, GPS-based, and/or based on any other suitable sensor, in accordance with data descriptive of the target location and/or the interface location.

In some embodiments, the drone driving system may include a drone battery replacement station and/or drone a battery recharging apparatus. In some examples, heat energy generated in the drone system (e.g., due to friction while the drone is driving on the guideway, may be converted by the recharging apparatus into electrical energy for recharging a drone battery. In some examples, the drone driving system may include recharging wires and/or pods arranged along the guideway, and which may be configured to operably engage with the drone and/or the drone coupling hardware for charging one or more components thereof.

In some embodiments, the coupling hardware may attach to the guideway from underneath. In the coupling procedure, guide wheels' axes orientation may be about in alignment with the gravitational forces acting on the coupling hardware, i.e., the wheels' circular surface may be about parallel to the Earth's plane. At least one of the plurality of wheels may comprise grooves on their perimeter. The grooves may be concave when viewing towards the wheels' axes of rotation. In a coupling process, the wheels' grooves may be pushed against the guideway so that a guideway portion (e.g., wire or cable portion) is forced into the grooves by two or more wheels from opposite sides. This way the guideway may be sandwiched between two wheels. At least one of the wheels may be an active driving wheel, configured to impart a driving force onto the guideway to cause displacement of the drone along the guideway. The remainder non-active wheels may be passive wheels, i.e., configured to rotate or roll freely along the guideway (e.g., wire) as a result of the driving force imparted onto the guideway by at least one active wheel. In some examples, all wheels may be active wheels.

In some other examples, one wheel that is positioned between two other wheels with respect to the longitudinal axis, may push the guideway against the grooves of two other wheels. As a result, the coupling hardware is secured in a suspending manner with the guideway in a formfitting manner with respect to gravitational force acting on the coupling hardware. Once the coupling hardware is securely attached to (also: operably engaged with) the guideway, the gravitation forces may act in a direction which may be (about) parallel to the wheels' rotation axes. In some examples, the coupling hardware may include a lever for pushing the plurality of wheels against the guideway.

In some other examples, a coupling hardware may be configured such that, when operably engaged with the guideway, a rotation axis of grooved wheels may extend about parallel to the horizontal plane and orthogonal to longitudinal axis Zg of the guideway. The grooved wheels may engage with the guideway from above such that after their operable engagement the guideway is positioned between the ground and the grooved wheels. The coupling hardware may be configured such that the combined weight of the drone and of the coupling hardware pulls the grooved wheels against the guideway from above the guideway towards the ground.

In some embodiments, a stationary or non-stationary platform may be equipped with a guideway for facilitating landing of drones onto, and for launching of drones from the platform. Such platforms may include, for example, land-based vehicles such as, for instance, a passenger car, a motorcycle, a bicycle, a transport vehicle (e.g., a bus, truck, a rail-based transport vehicle, etc.), a watercraft, a multipurpose vehicle such as a hovercraft, a military vehicle, combat vehicle, (e.g., a tank, an armored vehicle, an armored personnel carrier); a cable car; a train; a tramway; vehicles of an above ground and underground rapid transit system; and/or the like. For example, a platform such as a truck may include a plurality of guideways configured for receiving thereby one or more drones and releasing (also: dispatching or deploying) therefrom one or more drones, optionally, while the platform is.

In some embodiments, the guideway may also bear non-gravitational accelerating forces that may act onto a drone operably engaging with a guideway that is mounted onto a platform accelerating relative to Earth.

In some embodiments, a drone driving system may include a plurality of guideways of which one guideway may function as a relay or intermediate station with respect to another guideway, and/or to a target location (also: destination).

The coupling hardware may be replaceable to adapt to different types of drones and/or different types of guideways and/or guideway geometries.

In some embodiments, a guideway may comprise one or more docking locations arranged along its axis. The docking locations may facilitate securing a drone's coupling hardware with the guideway. In some examples, the docking locations may ensure that a safety clearance between two neighboring drones is maintained, while maximizing capacity of the guideway. In some examples, docking locations may be identifiable by markers or labels.

In some embodiments, a docking location may comprise one or more drone docking stations onto which a drone may dock. A drone docking station may be configured to travel along the guideway. A point on the guideway may be stationary relative to a reference frame, and the drone docking station may travel along the guideway by moving relative to the same reference frame. A drone docking station may be implemented, e.g., by guideway coupling hardware. The drone may comprise drone coupling hardware configured to operably couple with the docking stations' guideway coupling hardware. The drone may couple with the docking station while the docking station is traveling along the guideway. In some examples, a plurality of drones may operably engage with (e.g., dock onto) a same docking station. In some examples, only one drone may dock into a docking station. In some embodiments, a drone driving system may comprise a lifting apparatus configured for lifting a drone towards a guideway for coupling thereto, and for lowering a drone from the guideway. Optionally, such lifting apparatus may comprise a roller and tension elements (e.g., cables) for selectively winding and unwinding of tension elements onto the roller. A load such as a drone may be coupled with a tension element. The lifting apparatus may comprise a motor configured for imparting a rotating force onto the roller.

In some embodiments, a drone driving system may be configured to communicate with drones which guideways are available for use, in conjunction with corresponding route information.

A drone can detach from the guideway to fly and return to the same or a different guideway as many times as required.

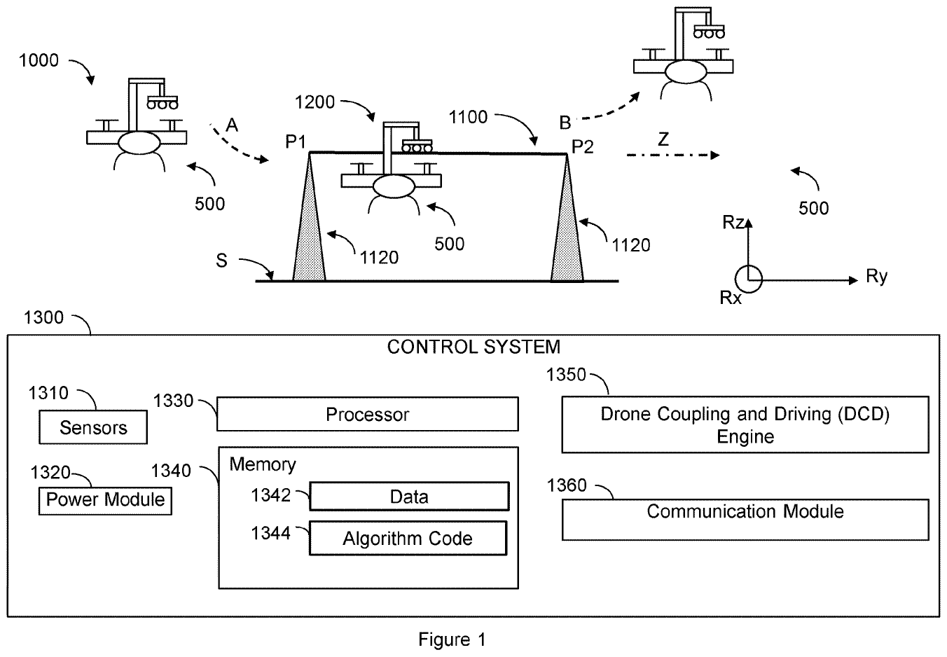

Reference is now made to FIG. 1. A drone driving system 1000 for a drone 500 may include a guideway 1100 extending between two points P1 and P2 along a route and having a longitudinal axis Z. Drone driving system 1000 may further include a coupling hardware 1200 which may be coupled or coupleable with a drone 500. Coupling hardware 1200 may comprise a coupling lock mechanism allowing selectively securing and unsecuring of the coupling hardware with guideway 1100 for allowing the drone to travel along guideway 1100. In some examples, coupling hardware 1200 may be configured for selectively securing and unsecuring thereof with a drone. In some examples, drone 500 may comprise coupling hardware 1200. In some examples, drone 500 may be retrofitted with coupling hardware 1200.

The guideway may be elevated relative to a ground surface S of a reference frame 600 (such as, for example, the Earth reference frame) having reference axes Rx, Ry, and Rz. The guideway may be supported by a support structure 1120 comprising, for example, at least one pole. In some examples, support structure 1120 may be stationary relative to the reference frame. In some examples, an element of support structure 1120 may extend upward from a ground surface, downward from a roof surface, and/or sideways from a wall surface. A support structure may comprise support elements such as, for example, a pole, a bar, and/or the like. In some examples, guideway 1100 may extend between two poles.

In some embodiments, drone 500 may comprise a propelling system configured to propel the mobile platform. The propelling system may for example comprise one or more electrically and/or fossil-based propelling apparatuses (e.g., propulsion-based, rotating wing-based, propeller-based apparatuses); inertial sensors (e.g., gyroscopes, acceleration sensors), non-inertial sensors (e.g., altimeters, pressure sensors); and/or the like.

An airborne drone 500 may operably engage with guideway 1100, e.g., as shown in FIG. 1 (arrow A), to bear most or all of the drone's weight. Furthermore, a drone that is operably engaged with guideway 1100 may disengage therefrom to become airborne (arrow B). Drone driving system 1000 may include a control system 1300 for controlling the various components and elements of system 1000, in accordance with some embodiments.

It will be appreciated that separate hardware components such as processors and/or memories may be allocated to each component and/or module of drone driving system 1000. However, for simplicity and without to be construed in a limiting manner, the description and claims may refer to a single module and/or component. For example, although a processor may be implemented by several processors, the following description will refer to a single processor as the component that conducts all the necessary processing functions of drone driving system 1000.

In an embodiment, all devices, components, modules and/or functionalities described with respect to control system 1300 may be included and/or implemented onboard drone 500. In an embodiment, some devices, components, modules and/or functionalities described with respect to control system 1300 may be included and/or implemented onboard drone 500 and some may be included and/or implemented external to drone 500, for example, by a server (not shown) and/or components of guideway 1100 and/or coupling hardware 1200.

In some embodiments, control system 1300 may comprise inertial and/or non-inertial sensors 1310, and a power module 1320, such as a battery a rechargeable battery, a solar panel, a power receiving interface, and/or the like, for storing power, and/or receiving power, and for providing the power as needed for the various modules and/or components of the system.

Control system 1300 may further include a processor 1330 and a memory 1340 which is configured to store data 1342 and algorithm code and/or machine learning (ML) model 1344. Processor 1330 may be configured to execute algorithm code and/or apply the ML model 1344 for the processing of data 1342 resulting in the implementation of methods, processes, and/or features, for example, as disclosed herein, which may be implemented by a drone driving engine 1350. For instance, drone 500, coupling hardware 1200, and sensors 1310 may operate in accordance with instructions received from one or more processors 1330 employed for implementing a drone coupling and driving (DCD) engine 1350.

In some examples, DCD engine 1350 may be configured for navigating an airborne drone 500 towards guideway 1100 for operably coupling drone 500 with the guideway. Navigation may be based on GNSS techniques, and/or GNSS-free (e.g., SLAM-based). In some embodiments, DCD 1350 may be configured to implement an image analysis module, for analyzing captured image data. Analysis may include, for example, identifying a guideway within a captured image. Identifying guideway 1100 may include image analysis techniques such as edge detection, corner detection, and/or the like. In examples, drone 500 may be remotely operated by an operator. In some examples, drone 500 may be fully autonomous or semi-autonomous.

It is noted that the term “processor”, optionally in conjunction with a “memory”, as used herein, may additionally or alternatively refer to a controller. Processor 1330 may be implemented by diverse types of processor devices and/or processor architectures including, for example, embedded processors, communication processors, graphics processing unit (GPU)-accelerated computing, soft-core processors and/or general-purpose processors. In some embodiments, processor 1330 may be implemented as a Central Processing Unit (CPU), a microprocessor, an electronic circuit, an Integrated Circuit (IC), and/or the like.

Memory 1340 may be implemented by diverse types of memories, including transactional memory and/or long-term storage memory facilities and may function as file storage, document storage, program storage, or as a working memory. The latter may for example be in the form of a static random-access memory (SRAM), dynamic random-access memory (DRAM), read-only memory (ROM), cache and/or flash memory. As working memory, memory 1340 may, for example, include, e.g., temporally-based and/or non-temporally based instructions. As long-term memory, memory 1340 may for example include a volatile or non-volatile computer storage medium, a hard disk drive, a solid-state drive, a magnetic storage medium, a flash memory and/or other storage facility. A hardware memory facility may for example store a fixed information set (e.g., software code) including, but not limited to, a file, program, application, source code, object code, data, and/or the like.

Drone control system 1300 may comprise a communication device 1360 configured to enable wired and/or wireless communication between the various components and/or modules of the system and which may communicate with each other over one or more communication buses (not shown), signal lines (not shown) and/or a network infrastructure. Communication device 1360 may be operative to receive instructions such as navigation and/or operation instructions from a remote human and/or computerized operator, transmitting images and/or other data to an external system, receiving readings and/or other data from external sources, and/or the like, via the network infrastructure.

The network infrastructure may be configured for using one or more communication formats, protocols and/or technologies such as, for example, to internet communication, optical communication, cellular communication, RF communication, telephony-based communication technologies and/or the like. In some examples, communication device 1360 may include I/O device drivers (not shown) and network interface drivers (not shown) for enabling the transmission and/or reception of data over the network. A device driver may for example, interface with a keypad or to a USB port. A network interface driver may for example execute protocols for the Internet, or an Intranet, Wide Area Network (WAN), Local Area Network (LAN) employing, e.g., Wireless Local Area Network (WLAN)), Metropolitan Area Network (MAN), Personal Area Network (PAN), extranet, 2G, 3G, 3.5G, 4G, 5G, 6G mobile networks, 3GPP, LTE, LTE advanced, Bluetooth® (e.g., Bluetooth smart), ZigBee™, near-field communication (NFC) and/or any other current or future communication network, standard, and/or system. The components detailed below may be implemented as one or more sets of interrelated computer instructions, executed for example by processor 1330 or by another processor. The components may be arranged as one or more executable files, dynamic libraries, static libraries, methods, functions, services, or the like, programmed in any programming language and under any computing environment.

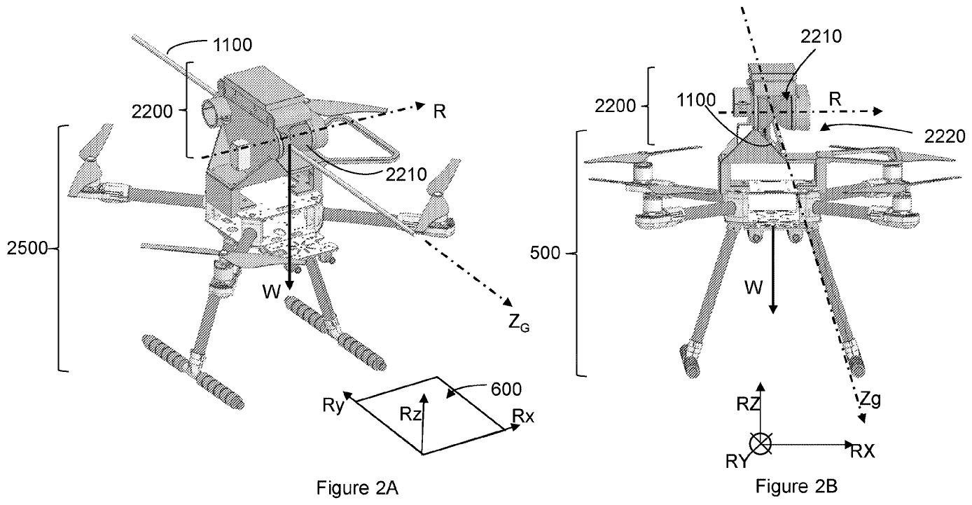

Further reference is now made to FIGS. 2A and 2B. A drone 2500 may be coupled with a coupling hardware 2200 with guideway 1100. When operably engaged in a suspended manner with guideway 1100, a rotation axis R of a plurality of bearing wheels 2210 of coupling hardware 2200 may extend above guideway 1100, perpendicular to axis Zg of guideway 1100 and about parallel with respect to a ground reference plane of world reference coordinate system 600. Bearing wheels 2210 thus engage with guideway 1100 from above such that guideway 1100 is positioned below rotational wheel axis R. Thus configured, the drone can be suspended by the guideway such that the combined weight W of drone 2500 and a coupling hardware 2200 pulls wheels 2110 against guideway 1100 towards the ground, in direction −Z, which is about perpendicular to guideway axis Zg and also about perpendicular to rotation axis R. As shown in FIG. 2A. coupling hardware 2200 may be configured to have an opening 2220 for allowing the coupling of guideway 1100 with coupling hardware 2200. In some examples, the body of the coupling hardware in conjunction with the drone may result in a C-shaped configuration or frame having opening 2220 configured to receive a portion of guideway 1100. At least one of the wheels may be an active driving wheel, configured to impart a driving force onto the guideway to cause displacement of the drone along the guideway. The remainder non-active wheels may be passive wheels, i.e., configured to rotate or roll freely along the guideway (e.g., wire) as a result of the driving force imparted by the at least one active wheel. In some examples, all wheels may be active wheels.

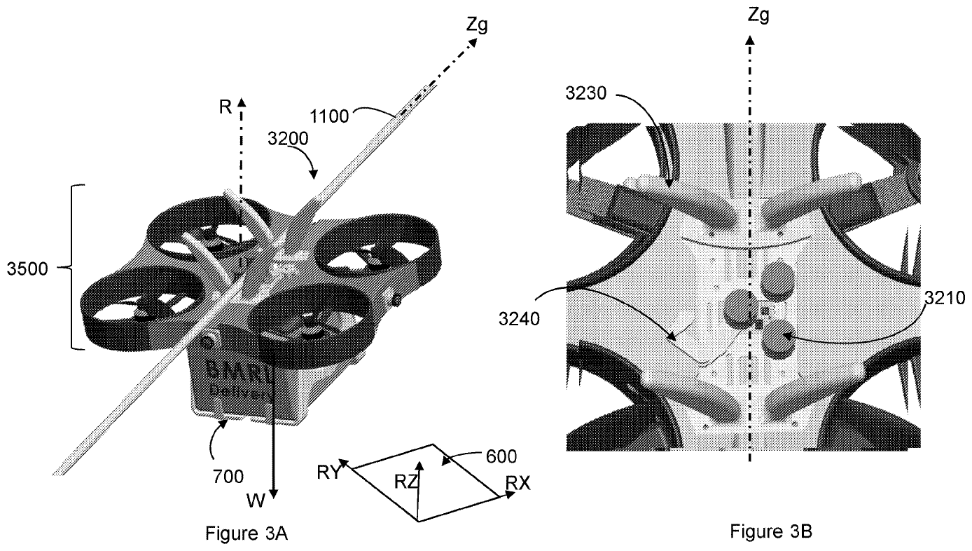

Additional reference is made to FIGS. 3A and 3B. In some embodiments, a coupling hardware 3200 of a drone 3500 may attach to guideway 1100 for coupling drone 3500 in a suspended manner from underneath with respect to gravitational force W acting onto drone 3500. Coupling hardware 3200 comprising bearing wheels 3210 is configured such that when operably engaging in a suspended manner, rotation axes R of bearing wheels' 3210 may be about perpendicular relative to guide axes Zg, and further about in alignment or parallel with gravitational force W acting on the suspended drone 3500. At least one of the plurality of wheels 3210 may comprise grooves on their perimeter. The grooves may be concave when viewed towards the wheels' axes of rotation. In a coupling process, the wheels' grooves may be pushed against respective engagement areas of guideway 1100 so that a guideway portion (e.g., wire or cable portion) is forced into the grooves by two or more wheels from opposite sides. Thus configured, guideway 1100 may be sandwiched between two, e.g., grooved wheels 3210. At least one of the wheels may be an active driving wheel, configured to impart a driving force onto the guideway to cause displacement of the drone along the guideway. The remainder non-active wheels may be passive wheels, i.e., configured to rotate or roll freely along the guideway (e.g., wire) as a result of the driving force imparted by the at least one active wheel. In some examples, all wheels may be active wheels.

Drone 3500 may have a V-shaped guide 3230 for assisting in guiding a drone 3500 approaching guideway 1100 to couple with guideway 1100. Drone 3500 may approach guideway 1100 such that guideway 1100 traverses the opening of V-shaped guide 3230. As the drone approaches the guideway and the guideway enters the V-shaped part, the drone can impart an upward force opposite to weight W until guideway 1100 is positioned between the at least two wheels 3210. A locking mechanism 3240 may then engage to secure guideway 1100 between the at least two wheels 3210 such that the drone can travel along the guideway. In some examples, the locking mechanism may push at least two opposite wheels against each other for securing the coupling hardware with the guideway.

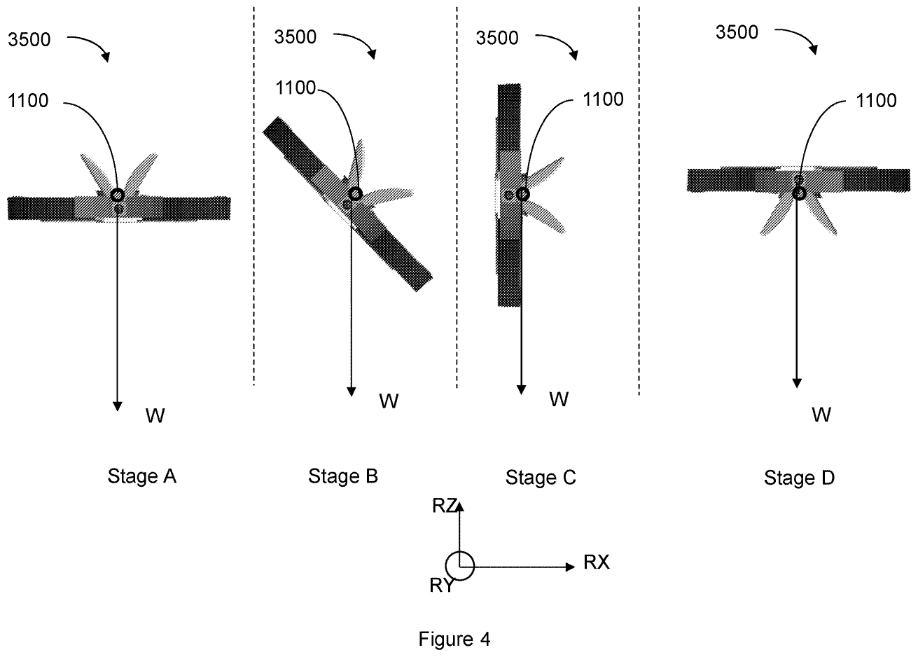

Additional reference is now made to FIG. 4. In some embodiments, a drone may be configured to rotate, in conjunction with the coupling hardware, around guideway 1100. The longitudinal axis Zg may constitute the drone's roll axis. Stage A shows a drone in an upright orientation in which the drone suspends from guideway 1100. i.e., guideway 1100 is pulled down by weight W. The term “suspends” may refer to situations in which the drone, when operably engaged with the guideway, is positioned below the guideway and above a reference surface (e.g., Earth ground surface) and the drone's weight W is pulling the drone towards the reference surface. Stages B and C show intermediate rotation stages before arriving at Stage D in which the drone is supported from below by guideway 1100 such that weight W is acting on guideway 1100 from above. Changing roll orientation of drone 3500 may allow avoiding obstacles along the guideway's route.

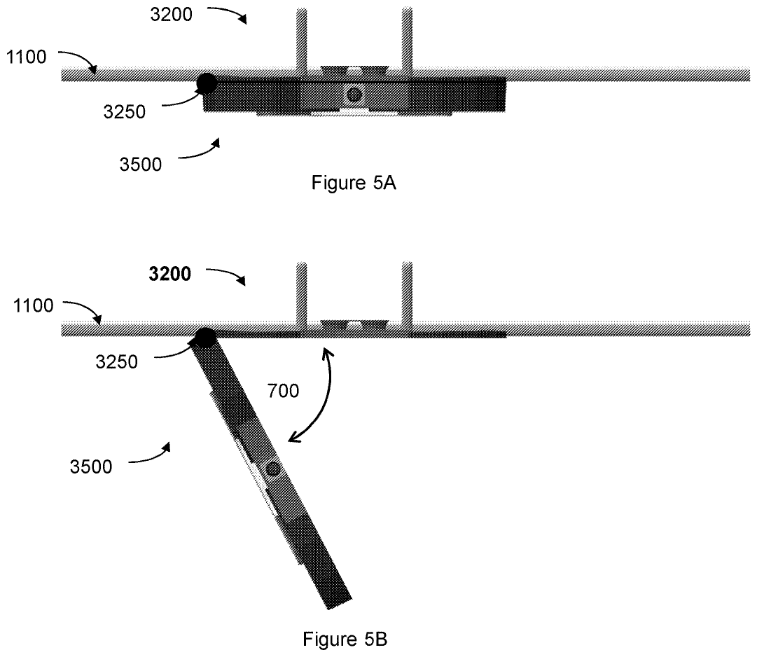

Further reference is made to FIGS. 5A and 5B. In some embodiments, the drone's propellers may provide thrust for advancing drone 3500 along the guideway. In some examples, coupling hardware 3200 may be configured to allow controlling the one or more orientations of the coupling hardware 3200 relative to drone 3500. This way, the drone's propellers can be used to provide thrust for advancing the drone. For example, a rotational joint 3250 may be employed which may allow opening an angle 700 between the coupling hardware and the drone and the propellers may provide thrust for advancing drone 3500 along guideway 1100. When the propellers provide thrust, the wheel may not be driven (e.g., passive), or at least one wheel may also be an active wheel for providing additional driving force.

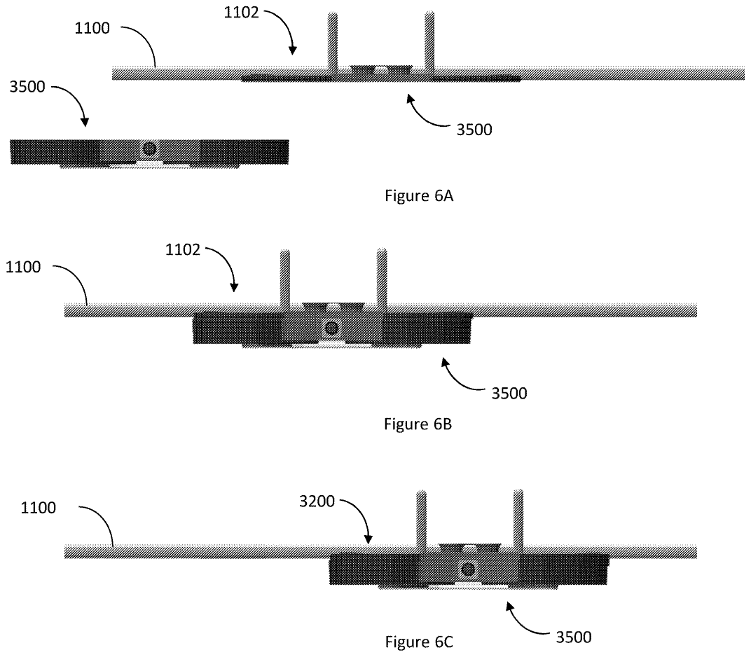

Additional reference is made to FIGS. 6A to 6C. In some embodiments, guideway 1100 may comprise one or more drone docking stations 1102 onto which a drone 3500 may dock. Drone docking stations may be configured to travel along guideway 1100. A point on guideway 1100 may be stationary relative to a reference frame, and drone docking station 1100 may travel along guideway by moving relative to the same reference frame. The reference frame may be a platform or Earth reference frame. A drone docking station 1102 may be implemented, e.g., by guideway coupling hardware. Drone 3500 may comprise drone coupling hardware (not shown) configured to operably couple with the docking stations' guideway coupling hardware 1102. Drone 3500 may couple with docking station 1102 while the docking station is traveling along guideway 1100.

It is noted that although certain embodiments may only be discussed with respect to a certain drone configuration, this should by no means be construed in a limiting manner. Accordingly, embodiments which are, for example, described with respect to drone 3500, may also be applicable with respect to drone 2500, and vice versa.

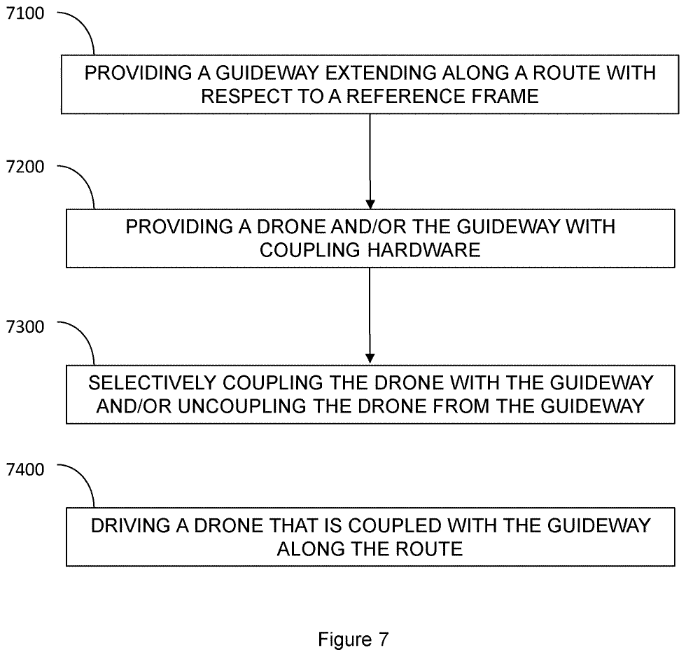

Additional reference is made to FIG. 7. A method for driving a drone may for example include, as indicated by block 7100, providing a guideway that extends along a route with respect to a reference frame.

As indicated by block 7200, the method may further include, for example, providing a drone and/or the guideway with coupling hardware.

As indicated by block 7300, the method may include, for example, selectively coupling the drone with the guideway and/or selectively uncoupling the drone from the guideway.

As indicated by block 7400, the method may further include, driving a drone that is operably coupled with the guideway along the route.

### ADDITIONAL EXAMPLES

In some examples a drone driving system, comprises:
a guideway that is elevated above a reference surface and extending along a route; and
a coupling hardware, wherein the coupling hardware is configured to operably engage with the guideway for driving a drone that is coupled with the coupling hardware along the guideway.

In some examples, when the drone is operably engaged with the guideway, no gravitational force, less than 50%, 50%, more than 50%, or all of the gravitational force acting onto the drone is borne by the guideway.

In some examples, the coupling hardware and guideway are configured such that an airborne drone can operably engage with the guideway.

In some examples, the drone driving system comprises a controller and a sensor for controlling, based on sensor output received by the controller, one of the following:
operable engagement of the drone with the guideway; operable disengagement of the drone from the guideway; the driving of the drone along the guideway, GNSS-based and/or GNSS-free drone navigation, or any combination thereof.

In some examples, the drone is controllable by an operator.

In some examples, the drone is an autonomously controlled drone.

In some examples, the coupling hardware and guideway are configured such that a drone can disengage from the guideway to become airborne.

In some examples, when the coupling hardware is operably engaged with the guideway, the drone suspends from the guideway.

In some examples, when the coupling hardware is operably engaged with the guideway, the guideway supports the drone from below with respect to gravitational force acting on the drone.

In some examples, the guideway comprises one of the following: a rope, a wire, cable, a conduit, a tube, a pipe, a track, or any combination thereof.

In some examples, the drone is retrofitted with coupling hardware.

In some examples, a part of the guideway extends about horizontally, and a part of the guideway extends about vertically relative to a ground reference surface.

In some examples, the guideway is curved and/or sloped relative to a reference surface.

In some examples, the guideway is stationary relative to a reference coordinate system and the coupling hardware is configured to cause the drone to travel relative to the reference coordinate system, along the route.

In some examples, the drone driving system comprises one or more docking stations arranged along the guideway for docking one or more drones thereto.

In some examples, wherein the coupling hardware is fixedly coupled with the guideway such that displacement of the guideway relative to a reference frame causes the drone to travel along the route.

In some examples a drone driving system is configured such that when the coupling hardware is operably coupled with the guideway, a package that is attached to the drone rolls or slides over a supporting surface.

In some examples, a drone driving system comprises wheels and/or slides which can be coupled with goods attached to the drone for rolling or sliding the goods over a supporting surface when the drone is traveling along the guideway.

In some examples, a drone driving system is configured to implement monitoring, maintenance, and/or inspections applications of facilities and/or buildings.

In some examples, a drone driving system is configured for cleaning and/or non-destructive testing of industrial, non-industrial, commercial and/or non-commercial facilities.

In some examples, a method for driving a drone comprises:
providing a guideway that is elevated above a reference surface and extending along a route; and
providing a coupling hardware, wherein the coupling hardware is configured to operably engage with the guideway for driving a drone that is coupled with the coupling hardware along the guideway.

In some examples, a drone driving method comprises operably engaging the drone with the guideway such that no gravitational force, less than 50%, 50%, more than 50%, or all of the gravitational force acting onto the drone is borne by the guideway.

In some examples, a drone driving method comprises operably engaging an airborne drone with the guideway.

In some examples, a drone driving method comprises controlling, based on sensor output received by the controller, one of the following:
operable engagement of the drone with the guideway; operable disengagement of the drone from the guideway; the driving of the drone along the guideway, or any combination thereof.

In some examples, a drone driving method comprises controlling the drone by an operator.

In some examples, a drone driving method comprises disengaging a drone from the guideway such that the drone becomes airborne.

In some examples, a drone driving method comprises operably engaging the drone with the guideway such that the drone suspends from the guideway.

In some examples, a drone driving method comprises operably engaging the drone with the guideway such that the guideway supports the drone from below with respect to gravitational force acting on the drone.

In some examples, the guideway comprises one of the following: a rope, a wire, cable, a conduit, a tube, a pipe, a track, or any combination thereof.

In some examples, a drone driving method comprises retrofitting a drone to comprise coupling hardware.

In some examples, a drone driving method comprises providing the guideway such to extend partially about horizontally and partially about vertically relative to Earth surface.

In some examples, a drone driving method comprises travelling of the drone, along the route,
wherein the guideway is stationary relative to a reference coordinate system; and
wherein the drone travels relative to the reference coordinate system.

In some examples, a drone driving method comprises wherein a point on the guideway is configured to travel along the route relative to a reference frame.

In some examples, a drone driving method comprises, wherein the reference coordinate system is the Earth reference frame.

In some examples, a drone driving method comprises displacing a point on the guideway relative to the reference frame such that to cause a coupling hardware that is fixedly coupled with the guideway to travel along the route.

In some examples, the guideway is supported by a support structure that is stationary with respect to the reference frame. Such support structure may include one or more support poles.

In some examples, a drone driving method comprises docking one or more drones onto docking stations arranged along the guideway.

In some examples, a drone driving method comprises undocking one or more drones from docking stations arranged along the guideway.

In some examples, a drone driving method comprises causing a package that is coupled with the drone to roll or slide over a supporting surface.

In some examples, a drone driving method comprises performing one of the following: monitoring, maintaining, inspecting, determining characteristics, and/or any combination of the aforesaid, of buildings, structures, industrial, non-industrial, commercial and/or non-commercial facilities.

In some examples, a drone driving method comprises one of the following: cleaning and/or performing non-destructive testing of buildings, structures, industrial, non-industrial, commercial and/or non-commercial facilities.

Unless otherwise defined, all technical and scientific terms used herein have the same meaning as commonly understood by one of ordinary skill in the art. The materials, methods, and examples provided herein are illustrative only and not intended to be limiting.

Implementation of the method and system of the present disclosure may involve performing or completing certain selected tasks or steps manually, automatically, or a combination thereof. Moreover, according to actual instrumentation and equipment of preferred embodiments of the method and system of the present disclosure, several selected steps may be implemented by hardware (HW) or by software (SW) on any operating system of any firmware, or by a combination thereof. For example, as hardware, selected steps of the disclosure could be implemented as a processor chip or a circuit. As software or algorithm, selected steps of the disclosure could be implemented as a plurality of software instructions being executed by a computer/processor using any suitable operating system. In any case, selected steps of the method and system of the disclosure could be described as being performed by a data processor such as, for example, a computing device for executing a plurality of instructions.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

Any digital computer system, unit, device, module and/or engine exemplified herein can be configured or otherwise programmed to implement a method disclosed herein, and to the extent that the system, module and/or engine is configured to implement such a method, it is within the scope and spirit of the disclosure. Once the system, module and/or engine are programmed to perform particular functions pursuant to computer readable and executable instructions from program software that implements a method disclosed herein, it in effect becomes a special purpose computer particular to embodiments of the method disclosed herein. The methods and/or processes disclosed herein may be implemented as a computer program product that may be tangibly embodied in an information carrier including, for example, in a non-transitory tangible computer-readable and/or non-transitory tangible machine-readable storage device. The computer program product may be directly loadable into an internal memory of a digital computer, comprising software code portions for performing the methods and/or processes as disclosed herein.

The methods and/or processes disclosed herein may be implemented as a computer program that may be intangibly embodied by a computer readable signal medium. A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a non-transitory computer or machine-readable storage device and that can communicate, propagate, or transport a program for use by or in connection with apparatuses, systems, platforms, methods, operations and/or processes discussed herein.

It should be understood that where the claims or specification refer to “a” or “an” element and/or feature, such reference is not to be construed as there being only one of that element. Hence, reference to “an element” or “at least one element” for instance may also encompass “one or more elements”.

Unless otherwise specified, terms such as, for example, ‘about’, ‘substantially’, and/or ‘close’ with respect to a magnitude or a numerical value may imply to be within an inclusive range of −10% to +10% of the respective magnitude or value.

It is important to note that the method may include is not limited to those diagrams or to the corresponding descriptions. For example, the method may include additional or even fewer processes or operations in comparison to what is described herein. In addition, embodiments of the method are not necessarily limited to the chronological order as illustrated and described herein.

“Coupled with” means indirectly or directly “coupled with”.

It should be noted that the term “item” as used herein refers to any physically tangible, individually distinguishable unit of packaged or unpackaged good or goods. Positional terms such as “upper”, “lower” “right”, “left”, “bottom”, “below”, “lowered”, “low”, “top”, “above”, “elevated”, “high”, “vertical” and “horizontal” as well as grammatical variations thereof as may be used herein do not necessarily indicate that, for example, a “bottom” component is below a “top” component, or that a component that is “below” is indeed “below” another component or that a component that is “above” is indeed “above” another component as such directions, components or both may be flipped, rotated, moved in space, placed in a diagonal orientation or position, placed horizontally or vertically, or similarly modified. Accordingly, it will be appreciated that the terms “bottom”, “below”, “top” and “above” may be used herein for exemplary purposes only, to illustrate the relative positioning or placement of certain components, to indicate a first and a second component or to do both.

Unless otherwise stated or applicable, the use of the expression “and/or” between the last two members of a list of options for selection indicates that a selection of one or more of the listed options is appropriate and may be made, and may be used interchangeably with the expressions “at least one of the following”, “any one of the following” or “one or more of the following”, followed by a listing of the various options.

As used herein, the phrase “A, B, C, or any combination of the aforesaid” should be interpreted as meaning all of the following: (i) A or B or C or any combination of A, B, and C, (ii) at least one of A, B, and C; and (iii) A, and/or B and/or C. This concept is illustrated for three elements (i.e., A, B, C), but extends to fewer and greater numbers of elements (e.g., A, B, C, D, etc.).

It is appreciated that certain features of the invention, which are, for clarity, described in the context of separate embodiments or example, may also be provided in combination in a single embodiment. Conversely, various features of the invention, which are, for brevity, described in the context of a single embodiment, example and/or option, may also be provided separately or in any suitable sub-combination or as suitable in any other described embodiment, example, or option of the invention. Certain features described in the context of various embodiments, examples and/or options are not to be considered essential features of those embodiments, unless the embodiment, example and/or option is inoperative without those elements.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as, for example, from 1 to 6 should be considered to have specifically disclosed subranges such as, for example, from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

While the invention has been described with respect to a limited number of embodiments, these should not be construed as limitations on the scope of the invention, but rather as exemplifications of some of the embodiments.

While certain features of the described implementations have been illustrated as described herein, many modifications, substitutions, changes, and equivalents will now occur to those skilled in the art. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations and embodiments described.

What is claimed is:

1. A drone driving system, comprising:
a guideway that is elevated above a reference surface and extending along a route; and
a coupling hardware, wherein the coupling hardware is configured to operably engage with the guideway for driving a drone that is coupled with the coupling hardware along the guideway.

2. The drone driving system of claim 1, wherein when the drone is operably engaged with the guideway, no gravitational force, less than 50%, 50%, more than 50%, or all of the gravitational force acting onto the drone is borne by the guideway.

3. The drone driving system of claim 1 and/or claim 2, wherein the coupling hardware and guideway are configured such that an airborne drone can operably engage with the guideway.

4. The drone driving system of any one or more of the preceding claims, comprising a controller and a sensor for controlling, based on sensor output received by the controller, one of the following:
operable engagement of the drone with the guideway; operable disengagement of the drone from the guideway; the driving of the drone along the guideway, or any combination thereof.

5. The drone driving system of any one or more of the preceding claims, wherein the drone is controllable by an operator.

6. The drone driving system of any one or more of the preceding claims, wherein the coupling hardware and guideway are configured such that a drone can disengage from the guideway to become airborne.

7. The drone driving system of any one or more of the preceding claims, wherein when the coupling hardware is operably engaged with the guideway, the drone suspends from the guideway.

8. The drone driving system of any one or more of the claims 1 to 6, wherein when the coupling hardware is operably engaged with the guideway, the guideway supports the drone from below with respect to gravitational force acting on the drone.

9. The drone driving system of any one or more of the preceding claims, wherein the guideway comprises one of the following: a rope, a wire, cable, a conduit, a tube, a pipe, a track, or any combination thereof.

10. The drone driving system of any one or more of the preceding claims, wherein the drone is retrofitted with the coupling hardware.

11. The drone driving system of any one or more of the preceding claims, wherein the guideway extends partially about horizontally and partially about vertically relative to Earth surface.

12. The drone driving system of any one or more of the preceding claims, wherein the guideway is stationary relative to a reference coordinate system and the coupling hardware is configured to cause the drone to travel relative to the reference coordinate system, along the route.

13. The drone driving system of any one or more of the preceding claims, comprising one or more docking stations arranged along the guideway for docking one or more drones thereto.

14. The drone driving system of any one or more of the preceding claims, wherein the coupling hardware is fixedly coupled with the guideway such that displacement of the guideway relative to a reference frame causes the drone to travel along the route.

15. The drone driving system of any one or more of the preceding claims, configured such that when the coupling hardware is operably coupled with the guideway, a package that is attached to the drone rolls or slides over a supporting surface.

16. The drone driving system of claim 14, comprising wheels and/or slides which are coupled with goods attached to the drone for rolling or sliding the goods over a supporting surface when the drone is traveling along the guideway.

17. The drone driving system of any one or more of the preceding claims, configured to implement monitoring, maintenance, and/or inspections applications of facilities and/or buildings.

18. The drone driving system of any one or more of the preceding claims, configured for cleaning and/or non-destructive testing of industrial, non-industrial, commercial and/or non-commercial facilities.

19. A method for driving a drone, the method comprising:
providing a guideway that is elevated above a reference surface and extending along a route; and
providing a coupling hardware, wherein the coupling hardware is configured to operably engage with the guideway for driving a drone that is coupled with the coupling hardware along the guideway.

20. The drone driving method of claim 19, comprising operably engaging the drone with the guideway such that no gravitational force, less than 50%, 50%, more than 50%, or all of the gravitational force acting onto the drone is borne by the guideway.

21. The drone driving method of claim 19 and/or claim 20, comprising operably engaging an airborne drone with the guideway.

22. The drone driving method of any one or more of the claims 19 to 21, controlling, based on sensor output received by the controller, one of the following:
operable engagement of the drone with the guideway; operable disengagement of the drone from the guideway; the driving of the drone along the guideway, or any combination thereof.

23. The drone driving method of any one or more of the claims 19 to 22, comprising controlling the drone by an operator.

24. The drone driving method of any one or more of the claims 19 to 23, comprising disengaging a drone from the guideway such that the drone becomes airborne.

25. The drone driving method of any one or more of the claims 19 to 23, comprising operably engaging the drone with the guideway such that the drone suspends from the guideway.

26. The drone driving method of any one or more of the claims 19 to 24, comprising operably engaging the drone with the guideway such that the guideway supports the drone from below with respect to gravitational force acting on the drone.

27. The drone driving method of any one or more of the claims 19 to 26, wherein the guideway comprises one of the following: a rope, a wire, cable, a conduit, a tube, a pipe, a track, or any combination thereof.

28. The drone driving method of any one or more of the claims 19 to 27, comprising retrofitting a drone to comprise coupling hardware.

29. The drone driving method of any one or more of the claims 19 to 28, comprising providing the guideway such to extend partially about horizontally and partially about vertically relative to Earth surface.

30. The drone driving method of any one or more of the claims 19 to 29, comprising travelling of the drone, along the route,
wherein the guideway is stationary relative to a reference coordinate system; and
wherein the drone travels relative to the reference coordinate system.

31. The drone driving method of any one or more of the claims 19 to 29, wherein a point on the guideway is configured to travel along the route relative to a reference frame.

32. The drone driving method of claim 30 and/or claim 31, wherein the reference coordinate system is the Earth reference frame.

33. The drone driving method of claim 31 and/or claim 32, comprising displacing a point on the guideway relative to the reference frame such that to cause a coupling hardware that is fixedly coupled with the guideway to travel along the route.

34. The drone driving method of claim 33, wherein the guideway is supported by a support structure that is stationary with respect to the reference frame.

35. The drone driving method of any one or more of the claims 19 to 34, comprising docking one or more drones onto docking stations arranged along the guideway.

36. The drone driving method of any one or more of the claims 19 to 35, comprising undocking one or more drones from docking stations arranged along the guideway.

37. The drone driving method of any one or more of the claims 19 to 36, comprising causing a package that is coupled with the drone to roll or slide over a supporting surface.

38. The drone driving method of any one or more of the claims 19 to 37, comprising one of the following: monitoring, maintaining, inspecting, determining characteristics, and/or any combination of the aforesaid, of buildings, structures, industrial, non-industrial, commercial and/or non-commercial facilities.

39. The drone driving method of any one or more of the claims 19 to 38, comprising:
cleaning and/or performing non-destructive testing of buildings, structures, industrial, non-industrial, commercial and/or non-commercial facilities.
